(19) United States
(12) Patent Application Publication
(10) Pub. No.: US 2023/0392647 A1
(43) Pub. Date: Dec. 7, 2023

(54) Harmony ball bearing

(71) Applicant: Charis Alexandrou, Nicosia (CY)

(72) Inventor: Charis Alexandrou, Nicosia (CY)

(21) Appl. No.: 17/805,176

(22) Filed: Jun. 2, 2022

(51) Int. Cl. F16C 33/38; F16C 19/16

(52) U.S. Cl. CPC F16C 33/3887; F16C 19/16

(57) ABSTRACT

Harmony is pleasing arrangement of parts: This ball bearing comprising a cage which is made of two identical, flat, parallel rings. A metal strip starts from the ring goes down towards the center then turns 90 degrees going towards the other ring then it turns 90 degrees and meets the other ring. These metal strips (stands) which touch the inner ring are positioned with space between them. Above these stands there are holes where immovable axles are inserted. Round these axles there are rotating rollers. These rollers are small in radius so that they do not touch the inner ring or outer ring. In between these rollers there are bigger balls moving circularly that touch and hold the rotating inner ring and stationary outer ring. There is a plurality of balls and rollers that move in harmony.

### CROSS REFERENCE TO RELATED APPLICATIONS

Not applicable

### BACKGROUND OF THE INVENTION

A ball bearing is the basis of the machine. It allows the various parts, shafts to rotate freely. Its uses are in machines, wheels generally shafts that rotate. There is a need for an efficient bearing that can withstand load. An efficient bearing means low fuel, energy consumption, low noise, smooth running of the axle, shaft and thus of the machine, longer life of the ball bearing and of the machine, lower operational temperature of the ball bearing and low possibility of malfunction. A car is equipped with 100 to 150 ball bearings, almost every machine needs ball bearings and wheels have ball bearings. They are essential. The harmony ball bearing consists of parts that move in agreement with each other. The balls that hold the load move freely.

### BRIEF SUMMARY OF THE INVENTION

In this invention the balls move freely. Their contact in front and on the rear are with rollers (cylinders) that move in harmony with the balls, in opposite circular direction with the balls. In other words, the balls move clockwise the rollers anti-clockwise. There is a ball then a roller then a ball and so on. That is the balls and the rollers are positioned alternately. The rollers rotate around axles. These axles are attached to a cage. A cage with stands that extend and have contact with the rotating inner ring. Therefore, the cage rotates. The rollers are small in diameter than the balls so they do not touch either the inner ring or the stationary outer ring. They only touch their axles and the balls. Therefore, only the balls are in contact with the outer stationary ring and the inner ring moving in circular motion. Conventional bearings consist of balls not moving in harmony touching parts that are stationary or moving in opposite direction thus colliding.

### BRIEF DESCRIPTION OF THE SEVERAL VIEWS OF THE DRAWING

FIG. 1 is the flat view of the entire ball bearing including all the parts.

FIG. 2 shows 2 balls and a roller in between in harmony.

FIG. 3 is a view from the top showing 2 balls and a roller in between, in the cage.

FIG. 4 is a simplified side view of the ball bearing showing the cage, the roller, the inner ring and the shaft.

### DETAILED DESCRIPTION OF THE INVENTION

Conventional bearings consist of balls next to each other rotating in opposite directions thus they collide, or they are in a cage which its sockets do not rotate in accordance with the rotating balls causing friction. They are not extremely efficient. The harmony ball bearing consists of rollers that are not in contact with the rotating inner ring (7) nor with the stationary supporting ring (6). They take movement from the balls (1) and their rotational movement agree with the movement of balls.

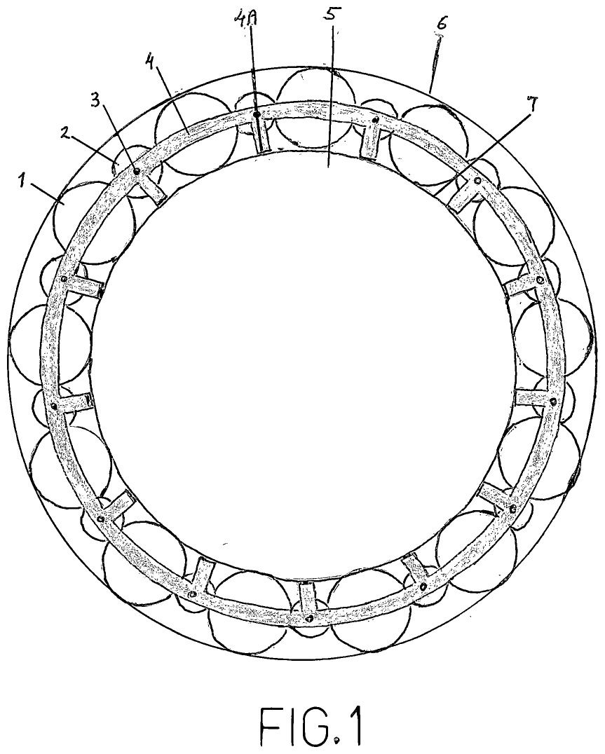

FIG. 1 illustrates the rotating inner ring touching only the balls (1) causing the balls to move in opposite direction than the inner ring. The balls touch the rollers (2) causing them to move in opposite direction than the balls. Therefore, all the rollers move in agreement with all the balls. What contains the balls and the rollers is the cage (4). The balls inside the cage move freely while the rollers are positioned around axles (3) that are fastened to the cage. As the shaft rotates it rotates the inner ring which rotates the balls and the cage. The cage rotates due two forces. The first is the rotating inner ring which touches the stands (4A) of the cage. The second is the balls that push the rollers in the direction of the rotating shaft. These two forces are in the same direction. The balls rotate the rollers.

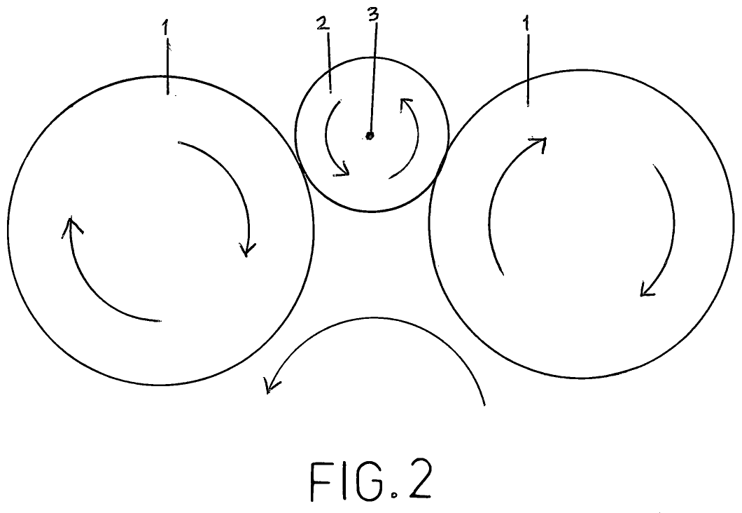

FIG. 2 demonstrates the movement of the balls (1), the rollers (2) and the shaft (lower curved arrow). They move in harmony. The shaft moves anti-clockwise, the balls clockwise and the roller anti-clockwise. The movement comes from the shaft the inner ring is attached to it and it moves the two balls. The balls (1) move the roller (2). The roller rotates around an axle (3).

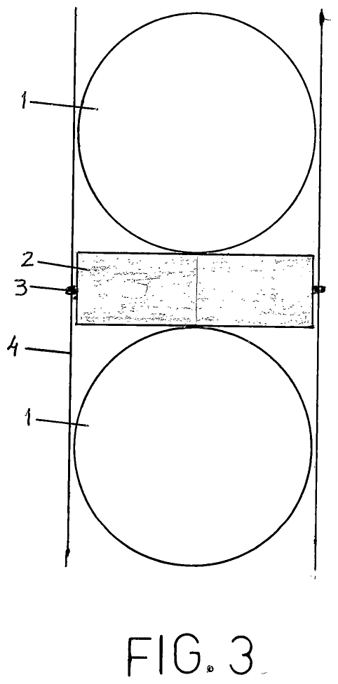

FIG. 3 is a view from the top showing 2 balls (1), the roller (2) rotating around the axle (3) which is attached to the cage (4). The walls of the cage in FIG. 3 the vertical lines are slightly wider than the contained balls for the balls to rotate freely without friction. The balls rotate rotating thus the roller (2). The balls should not fit tightly with the rollers because when the ball bearing works for a considerable time the temperature rises causing the balls and the rollers to expand pushing each other and preventing the ball bearing from running smoothly.

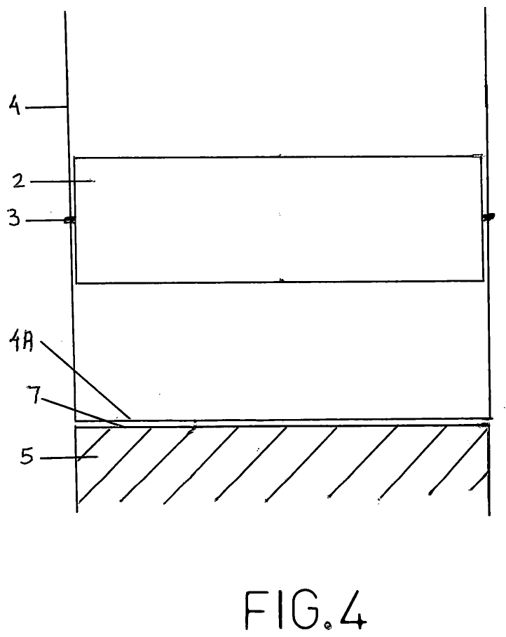

FIG. 4 is a side view of the ball bearing without the ball. The shaft (5) which rotates the inner ring (7). Between the inner ring (7) and the stand of the cage (4A) there is a tiny space which is the lubricant. There is the possibility that the cage (4) will move faster than the balls thus the rollers (2) will touch the balls from behind a lubricant will make this touch weak. The harmony ball bearing should initially be made without using lubricant and observe the relation between the cage and the balls. The ideal is the rollers not to touch the balls either in front or behind. If the rollers touch the balls from behind the number of stands (4A) should be reduced. For example, not under every axle (3) should there be a stand but under numbers 1, 3, 5, 7, 9, 11 axles.
(1) balls are placed between rollers they are larger than the rollers preventing the rollers to touch either the rotating inner ring or the stationary outer ring. The rollers touch only the balls. The balls should be made of steel and have such radius that do not touch the cage the sides of the cage- or the rollers when stationary reducing friction and give room for expansion from heat.
(2) rollers should be made of steel. They are cylinders with a hole of the cross section. The radius of the hole should be half of the radius of the cylinder. The rollers should be slightly shorter in length than the distance between the 2 sides of the cage to avoid friction with the sides of the cage. The radius of the roller should not be either too small or too big. The size of the radius does not matter as far as friction is concerned because Friction=μF. Where μ is the coefficient of friction and F is the force which pushes the roller to the axle. However, when the roller is small in radius it rotates with higher circular velocity. Higher circular velocity means more friction. A large roller rotates with lower circular velocity and suffers less friction. The drawback of a large roller is that the distance between the balls, which them alone hold the load, is big rendering the ball bearing incapable of holding heavy loads. Therefore, the radius of the roller with the axle inside it should be ¼ to ½ of the radius of the ball. The rollers are cylinders. They can be spherical like a ball or cones: two cones which their edges meet in the center resembling a water clock. If the rollers are spherical the balls (1) will either move left or right touching the sides of the cage. If the rollers are like cones the balls will push the cones (rollers) to the left or to the right thus the cones (rollers) will have friction with the sides of the cage when they rotate.
(3) axle is attached to the cage. A hole is made above the stand (4A) and it is in the middle of the width of the circular ring of the cage as seen in FIG. 1. The axle is inserted between the 2 holes of the 2 sides of the ring of the cage. The axle is made of steel. Here lubrication is vital between the axle and the roller which are in contact.
(4) cage consists of two identical rings that are connected with the stands (4A). They are rings with extensions, stands (4A) below the holes of the axles (3).
(4A) stands are extensions, strips that start from the ring of the cage go down until they reach the inner ring then they turn 90 degrees going until they meet the strip from the other ring of the cage. The stands of the cage touch the inner ring so there is the possibility of using lubricant. For the lubricant to not enter the stands, the stands should be U shaped letting the lubricant to pass under the stand and not above it. Also, U shaped stands reduce the friction between the stands and the inner ring. If the stand is flat and not U shaped it will touch the inner ring much more than if it was U shaped (semicircle).
(5) shaft the big rotating axle that is in contact with the inner ring of the ball bearing.
(6) the outer ring which is stationary and is fixed to the surrounding environment. It is circular.
(7) the inner ring which rotates with the same circular velocity as the shaft because it is attached to it. It is circular and can be attached to the shaft by screws or ditches.

1. A ball bearing comprising:
balls (1)
rollers (2)
axles (3)
cage (4)
stands of cage (4A)
shaft (5)
outer stationary ring (6)
inner ring (7)

2. The bearing of claim 1,
wherein the size of the radius of the roller varies.

3. The bearing of claim 1,
wherein the shape of the roller is spherical like a ball.

4. The bearing of claim 1,
wherein the shape of the roller is two cones which their edges are attached in the center resembling a water clock.

5. The bearing of claim 1,
wherein the stands of the cage where they touch the inner ring are U shaped.
